(19) United States
(12) Patent Application Publication
(10) Pub. No.: US 2010/0191872 A1
(43) Pub. Date: Jul. 29, 2010

(54) CONTROLLER

(75) Inventors: Hirokazu Iguchi, Tokyo (JP); Yuuji Takabayashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/696,234

(22) Filed: Jan. 29, 2010

(30) Foreign Application Priority Data
Jan. 29, 2009 (JP) 2009-018270

(51) Int. Cl. G06F 3/00; G06F 12/08

(52) U.S. Cl. 710/13; 711/147; 711/E12.016

(57) ABSTRACT

A controller includes an inputting/outputting portion, which receives data from a field device and outputs operated data to the field device, a flash memory including a file system, and a file system driver, which reads data held on a shared memory and writes the read data into the file system to save the data in the file system. The file system driver has a power-failure-safe function.

### TECHNICAL FIELD

The present disclosure relates to a controller for receiving data from a field device via an inputting/outputting portion and outputting controlled/operated data to the field device, and for reading data held on a shared memory and writing the data into a file system, which is built up on a flash memory via a file system driver, to save the data therein.

### RELATED ART

FIG. 3 is a functional block diagram showing a configurative view of a controller in the related art. A controller 1 executes control based on a predetermined control program by communicating with field devices 2a, 2b, . . . , 2n in a plant.

The controller 1 includes a controlling portion 3 that is operated by CPU. The controlling portion 3 applies the operation to process data acquired from the field devices 2a, 2b, . . . , 2n in the plant via an inputting/outputting portion 4 based upon the predetermined control program, and outputs the operated results to the field devices 2a, 2b, . . . , 2n in the plant via the inputting/outputting portion 4.

The controller 1 includes a shared memory 5. A data holding portion 51 controlled by a management task portion 6 is formed in the shared memory 5, and the data whose recording is needed for the purpose of logging, or the like are held temporarily in the data holding portion 51.

The controller 1 includes a flash memory 7 formed of EEPROM, or the like. In the flash memory 7, a control program 71 for causing CPU of the controlling portion 3 to operate is installed, and a file system 72 for holding necessary data for a predetermined period is built up.

The controller 1 includes a file system driver 8 used to write data into the file system 72. The management task portion 6 reads the data, which are to be held as a file, from the data holding portion 51 and transfers the data to the file system driver 8, and writes the data into the file system 72.

The merit acquired when the controller is equipped with the file system will be explained hereunder. In the related art, when the file system is applied to the controller that executes mainly the control, control data can be accumulated for the long term in the controller.

In the related art, these functions are implemented by SCADA (Supervisory Control And Data Acquisition) that is connected via the network. However, when the controller is equipped with these functions, the stand-alone controller that is not based upon SCADA can be implemented.

The circumstances in which the controller that is equipped with such functions is effectively used will be explained hereunder. With the increase of a demand for energy, the exploitation of small-scale gas fields, which are scattered at remote sites and whose investment effect is estimated small until now, and the like is promoted actively nowadays.

In such circumstances, infrastructures such as power supply equipments, communications, etc. enough to use the control system in the related art are not provided. Therefore, a stand-alone controller equipped with a file system that can save data for a long term is requested.

As the power supply infrastructure in such circumstances, the system whose power supply circumstance can deal with the unstable environment, e.g., in which the controller is driven by solar cells and batteries, is required. For this reason, the controller 1 has a built-in power supply portion 9 as the case may be, and a power is fed to this power supply portion 9 from an uninterruptible power supply (UPS) 10 provided on the outside. Thus, the measure is taken to prevent such an even that an interruption of control is caused due to a power interruption, or the like.

[Patent Literature 1] JP-A-2002-351504

In the configuration of the controller in the related art, following problems arise.

(1) When an interruption of power is caused due to a power failure, or the like during the change of data in the file system, the file system is broken down in some cases. That is, because an operation to be taken at a time of an interruption of power is not considered in the file system such as FAT (File Allocation Table), or the like in the related art, such a problem exists that the mismatching is caused between managed information in the file and actual data in the file. When the mismatching is caused, it is possible that the data are corrupted in not only the file being updated now but also other files in the file system.

(2) In the related art, the controller is normally shut down by using the power supply such as UPS, or the like such that the change of data in the file system is not caused when a power failure is brought about. When the file system is broken down, the maintenance operation such as check of the file system, backup/restore, or the like is needed.

(3) When an interruption of power is caused due to a power failure, or the like during the change of file, the file system is broken down. When the file system is broken down, in some cases the important file of OS is corrupted in addition to data corruption. As a result, it is unfeasible to operate the controller when such important file of OS is corrupted, and thus replacement/maintenance of such important file is needed.

(4) Because the external equipment such as UPS, or the like is needed separately to prevent the power failure, the equipment is expensive. Therefore, such controller is not suitable for the application in which the simple instrumentation is desired to suppress a cost even in the environment in which the power supply situation is bad.

### SUMMARY

Exemplary embodiments of the present invention provide a controller capable of preventing a failure of a file system when an interruption of power is caused due to a power failure, or the like in changing data in the file system.

A controller according to an exemplary embodiment of the present invention, comprises:

an inputting/outputting portion, which receives data from a field device and outputs operated data to the field device;

a flash memory including a file system; and

a file system driver, which writes data read from a shared memory into the file system to save the data in the file system, the file system driver having a power-failure-safe function.

In the controller, the file system driver may hold a data area and a data value saved in the file system before the data are written into the file system and a data area and a data value to be saved in the file system after the data are written into the file system.

According to the controller of the present invention, since the power-failure-safe file system driver is applied to the controller, a risk of the failure due to the power failure can be lessened, the maintenance operation can be lessened, and the controller that can stand up to scattered applications at the remote sites can be implemented.

Further, the external equipment such as UPS, or the like is not needed, and as a result the equipment can be built up inexpensively in the environment in which the power supply situation is bad.

Other features and advantages may be apparent from the following detailed description, the accompanying drawings and the claims.

### BRIEF DESCRIPTION OF THE DRAWINGS

FIG. 1 is a functional block diagram showing a configurative example of a controller according to an exemplary embodiment of the present invention.

FIG. 2 is an explanatory view of an operation of a file system driver equipped with a power-failure-safe function.

FIG. 3 is a functional block diagram showing a configurative view of a controller in the related art.

### DETAILED DESCRIPTION

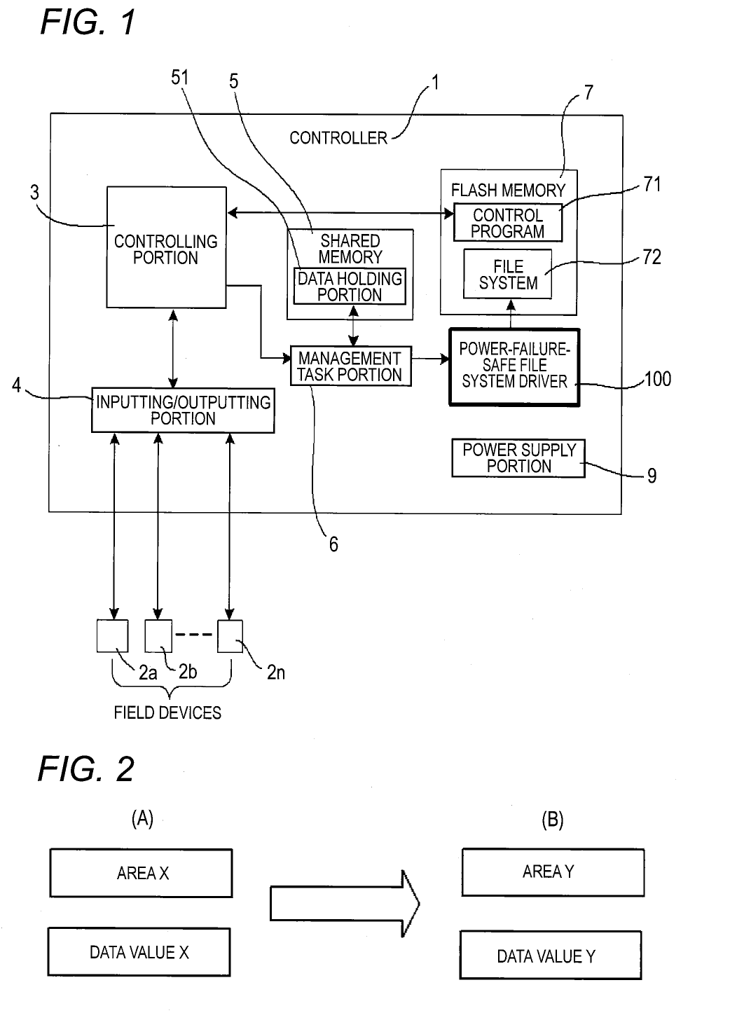

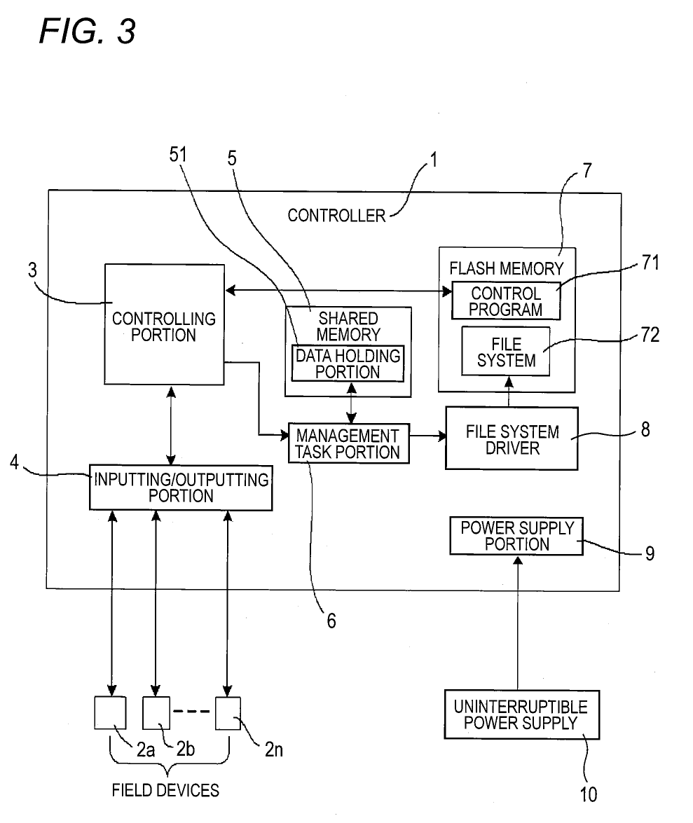

The present invention will be explained in detail with reference to the drawings hereinafter. FIG. 1 is a functional block diagram showing a configurative example of a controller according to an exemplary embodiment of the present invention. The controller 1 holds the communication with the field devices 2a, 2b, . . . , 2n in the plant, and applies the control based upon a predetermined control program.

The controller 1 includes the controlling portion 3 that is operated by CPU. The controlling portion 3 executes the operation of the process data acquired from the field devices 2a, 2b, . . . , 2n in the plant via the inputting/outputting portion 4 based upon a predetermined control program, and outputs the operated result to the field devices 2a, 2b, . . . , 2n in the plant via the inputting/outputting portion 4.

The controller 1 includes the shared memory 5. The data holding portion 51 controlled by the management task portion 6 is formed in the shared memory 5, and the data whose recording is needed for the purpose of logging, or the like are held temporarily in the data holding portion 51.

The controller 1 includes the flash memory 7 formed of EEPROM, or the like. In the flash memory 7, the control program 71 for causing CPU of the controlling portion 3 to operate is installed, and the file system 72 for holding necessary data for a predetermined period is built up.

The controller 1 includes a power-failure-safe file system driver 100 used to write the data into the file system 72. The file system driver 100 is equipped with a power-failure-safe function. The management task portion 6 reads the data, which are to be held as a file, from the data holding portion 51 and transfers the data to the power-failure-safe file system driver 100, and writes the data into the file system 72.

A feature of the present invention resides in such a configuration that the data being read from the data holding portion 51 of the shared memory 5 by the management task portion 6 are written onto the file system 72 being built up on the flash memory 7 via the power-failure-safe file system driver 100 and are saved in the file system 72.

FIG. 2 is an explanatory view of an operation of the file system driver equipped with the power-failure-safe function. When the process of changing the data, for example, changing a data area X and a data value X which are saved in the file system 72 before the change as shown in (A) of FIG. 2 to a data area Y and a data value Y to be saved in the file system 72 after the change as shown in (B) of FIG. 2 is executed, the power-failure-safe file system driver 100 holds these data (the data area X, the data value X, and the data area Y, the data value Y) saved in the file system 72 before and after the change in changing the data in the file system 72.

The power-failure-safe file system driver 100 still holds the data saved in the file system 72 before the change when the process is interrupted during the change owing to the power failure. Therefore, the contents of the file system 72 can be easily restored into the original state.

In this manner, since the power-failure-safe file system driver is applied to the controller, a risk of the failure due to the power failure can be lessened, the maintenance operation can be lessened, and the controller that can stand up to scattered applications at the remote sites can be implemented.

In the controller to which the present invention is applied, the fatal influence exerted by the breakdown of the file system can be avoided. Therefore, the external equipment such as UPS, or the like is not needed, and as a result the equipment can be built up inexpensively in the environment in which the power supply situation is bad.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A controller comprising:
an inputting/outputting portion, which receives data from a field device and outputs operated data to the field device;
a flash memory including a file system; and
a file system driver, which writes data read from a shared memory into the file system to save the data in the file system, the file system driver having a power-failure-safe function.

2. A controller according to claim 1, wherein the file system driver holds a data area and a data value saved in the file system before the data are written into the file system and a data area and a data value to be saved in the file system after the data are written into the file system.
